(19) United States
(12) Patent Application Publication
(10) Pub. No.: US 2008/0279338 A1
(43) Pub. Date: Nov. 13, 2008

(54) Self sealing X-Ray film container

(76) Inventors: Anna Marie Scott, Dallas, TX (US); Raymond Green, McKinney, TX (US)

Correspondence Address: CARSTENS & CAHOON, LLP, P O BOX 802334, DALLAS, TX, 75380, US

(21) Appl. No.: 11/800,672

(22) Filed: May 7, 2007

(51) Int. Cl. G03B 42/04

(52) U.S. Cl. 378/188

(57) ABSTRACT

The invention is generally a self-closing film container for storing undeveloped film, particularly X-Ray film, and more particularly still dental X-Ray film. One embodiment of the container is an opaque box having an angular mouth at one end, and a spring-loaded lid fitted over the mouth such that the lid snugly closes over the mouth, and is opened only when a force is placed on the lid. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD OF THE INVENTION

The invention relates generally to dental equipment, and more particularly to dental equipment used in dental X-Ray film processing.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

X-Ray film (also called an “X-Ray”) is expensive—this is particularly true for the larger panoramic X-Ray film, such as those used in dental offices. If unused film is exposed to light it is ruined. Often the lid to the stored film box is inadvertently left on the counter after use instead of being placed back on the box. When the dark room door is opened while the lid is off of the box, light enters the box and the stored film is ruined. This causes the loss of an entire box of unused film. If an office only purchases one box of film at a time, the user may not be able to take needed x-rays for several days while a new box is ordered and delivered. This wastes money and materials and prevents the use of a valuable diagnostic tool. Accordingly, the present invention provides a device that solves the problem of unintentionally exposing the x-ray film to light.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a self-closing X-Ray film container system.

FIG. 2 is a self-closing X-Ray film container.

FIG. 3 shows more detail of the self-closing X-Ray film receptacle.

FIG. 4 shows more detail for the self-closing X-Ray film container lid.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for-functioning-” or “step for functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. Words and phrases are to be given their ordinary plain meaning unless indicated otherwise.

### DESCRIPTION OF THE DRAWINGS

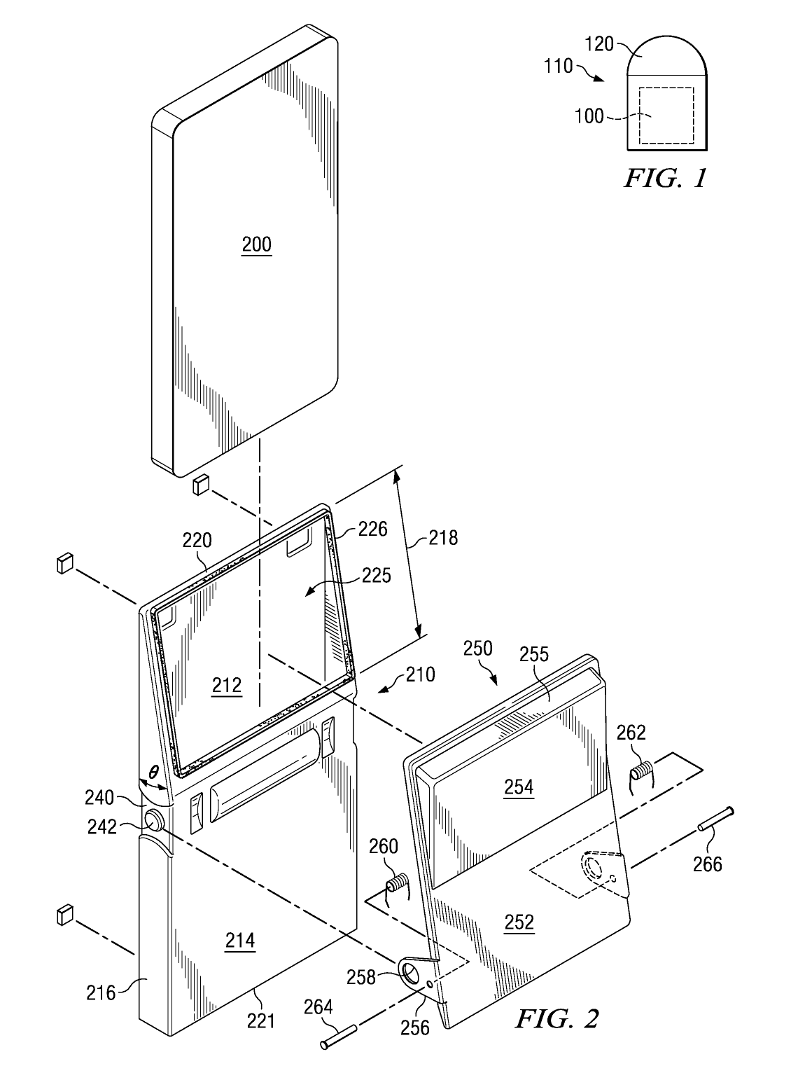

One embodiment of the invention may be described as a system that prevents accidental exposure of X-Ray film (or other light sensitive material) to light. Accordingly, FIG. 1 is a self-closing X-Ray film container system. The system includes an opaque receptacle 110 capable of holding film 100. The film herebelow is sometimes specifically articulated to be dental X-Ray film, however, it is understood that the invention is not limited to dental X-Ray film but may be used to prevent accidental exposure of film to light for a great variety of films, including X-Ray film as well as film used to take photographs. The receptacle 110 is an opaque (or sufficiently light-resistant) device capable of holding the film 100. Of course, the receptacle 110 should be opaque to X-Ray spectrum in those designs that are to hold X-Ray film. Exemplary receptacles 100 include neoprene bags, cardboard boxes, plastic form-molded receptacle, and the like. The system also includes a self-closing opening 120 that closes and remains light-proof closed such that the film 100 is protected from exposure to light entering the opening 120. Exemplary self-closing openings include spring-loaded openings, elastically-closing openings, clips, and equivalents. Further understanding of the invention may be obtained by the below discussion of a preferred embodiment, and simultaneous reference to FIGS. 2-4.

FIG. 2 illustrates a self-closing dental X-Ray film container which in one embodiment accepts dental panoramic X-Ray film. Typically the container accepts bulk sheets of unexposed x-ray film where typically 50 sheets are packed together, and that film may or may not be stored in a box. Accordingly, those familiar with dental X-Ray film understand that dental X-Ray film that is used to take a panoramic X-Ray is typically stored in a box which may hold several dental X-Ray films. The block 200 represents a stack of X-Ray films, such as dental, medical, veterinary, or other X-Ray films or a dental panoramic X-Ray film box.

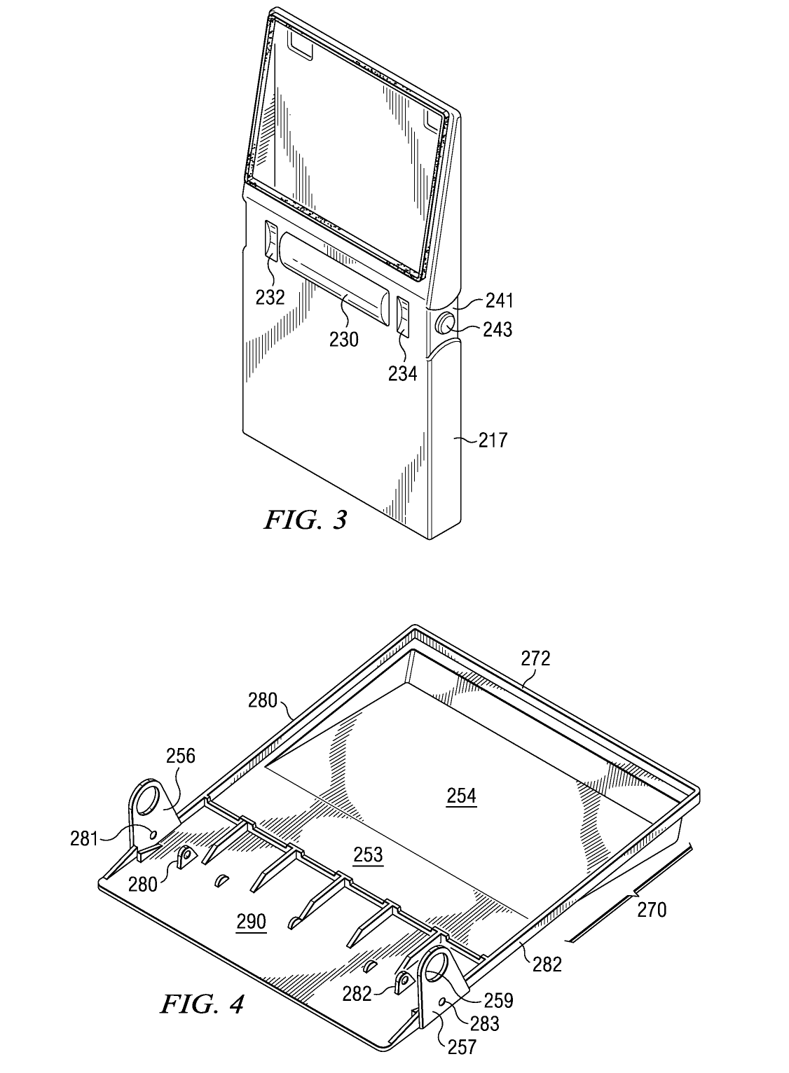

FIG. 3 illustrates a self-closing dental X-Ray film receptacle 210 in more detail, while FIG. 4 shows more detail for a self-closing dental X-Ray film container lid 250. The container includes an opaque and light-proof generally box-shaped receptacle 210 having an interior and an exterior, a top 220, a bottom 221, a front 214 and a back 212, and a first side 216 and a second side 217. The interior is defined by the volume surrounded by the top, bottom, front, back and sides, and the exterior is defined by the non-interior portions of the top, bottom, front, back and sides. By light-proof it is meant that the receptacle 210 has no openings or breaks from the interior to the exterior except as defined herein. Accordingly, the receptacle 210 has an angular opening defining a mouth 225, the opening extending substantially across the top 220, extending along a selected length 218 of each side 216, 217 at an angle theta such that the opening extends to the front 214 of the receptacle 210. The length 218 is selected to facilitate the entry and removal of the stack of film that has been removed from the box 200, and will vary across alternative embodiments depending on the type and quantity of film to be stored in the container. In an alternative embodiment, the mouth 225 is edged with an opaque spongy material such as a poly foam 226. The receptacle 210 includes a pivot mount 242 located below the mouth 225 on the first side 216, and a second pivot mount 243 located below the mouth 225 on the second side 217. In an alternative embodiment, the pivot mounts 242, 243 are recessed into pivot recesses 240, 241 which are shaped to accommodate the travel of a lid 250. The receptacle 210 front 214 may also include a raised fulcrum portion 230, as well as generally concave box guides 232, 234 which secure the box 200 in the receptacle 210.

The container also utilizes the opaque and light-proof lid 250 having a generally planar top 252 and a bottom 253, and a first side 280 and a second side 282. The lid 250 includes a first flange 256 protruding from the bottom 253 at the first side 280, the first flange includes a pivot mount coupling 258. The lid 250 also has a second flange 257 protruding from the bottom 253 at the second side 282, the second flange includes a pivot mount coupling 259. Here, each pivot mount coupling is embodied as a hole in each flange sized to couple with each pivot mount 242, 243, such that the lid 250 may pivot thereupon and cover the mouth 225.

The area of the lid bottom 253 behind the flanges 256, 257 defines a force area 290. A force generating element, here embodied as two spring coils 260, 262, is coupled between the lid's force area 290 and the receptacle 210 such that the bottom of the lid 253 is forced upon the mouth 225 to form a light-proof seal. The first spring coil 260 is secured with a first coupling pin 264 that mounts to a first pin hole 281 and a second hole located in a first mounting flange 280. Similarly, the second spring coil 262 is secured with a second coupling pin 266 that mounts to a third pin hole 283 and a fourth hole located in a second mounting flange 282. Thus, when the lid 250 is coupled to the receptacle 210 at the pivot mounts 242, 243 the spring coils 260, 262 place a force on the force area 290 of the lid 250 that pushed the force area 290 away from the receptacle 210. This force is then transferred via the fulcrum portion 230 to the lid's bottom 253, which is thus forced to cover the mouth 225.

The lid 250 includes an opaque light-proof spongy sealing material disposed about any bottom portion of the lid that couples to the mouth 225, such as a poly foam. Additionally, the bottom 253 of the lid 250 may provide an offset lip 272 to cover a portion of the sides 216, 217 of the receptacle 210 to further prevent light from entering the mouth 225.

The lid 250 also includes a lobe 254 that accommodates a portion of at least one film, or in the present embodiment, the stack of X-rays. From FIGS. 2 and 4 it is seen that the lobe 270 is shaped like a cross-section of a polyhedron, shown here generally as the cross-section of a cube. The lobe 270 has a front 254, a top 255, a first side, a second side, and an interior, and as shown in FIGS. 2 and 4, the front 254 protrudes away from the top 252 of the lid 250.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A self-closing X-Ray film container, comprising:
an opaque receptacle having a mouth and a lid;
the lid is closable over the mouth such that no light enters the receptacle.

2. A self-closing X-Ray film container, comprising:
a light-proof and opaque generally box-shaped receptacle having an interior and an exterior,
the receptacle having a top and a bottom, a front and a back, and a first side and a second side,
the receptacle having an angular opening defining a mouth, the opening extending substantially across the top, extending along the length of each side at an angle such that the opening extends to the front of the container,
a first pivot mount located below the mouth on the first side,
a second pivot mount located below the mouth on the second side;
an opaque lid having a generally planar top and a bottom, and a first side and a second side,
the lid having a first flange protruding from the bottom at the first side, the first flange having a pivot mount coupling,
the lid having a second flange protruding from the bottom at the second side, the second flange having a pivot mount coupling;
the area of the lid bottom behind the flange defining a force area;
each pivot mount coupling of the lid coupled to a pivot mount, such that the lid may pivot thereupon and cover the mouth;
a force generating element coupled between the lid force area and the container such that the bottom of the lid is forced upon the mouth to form a light-proof seal.

3. The container of claim 2 further comprising a light-proof sealing material disposed about the mouth.

4. The container of claim 3 wherein the sealing material comprises a poly foam.

5. The container of claim 2 further comprising a light-proof sealing material disposed about the bottom of the lid that couples to the mouth.

6. The container of claim 2 wherein the interior of the receptacle accommodates at least one film.

7. The container of claim 6 wherein the film is a dental X-Ray film.

8. The container of claim 2 wherein the interior of the receptacle accommodates a stack of dental X-Ray films.

9. The container of claim 2 wherein the lid comprises a lobe that accommodates a portion of at least one film.

10. The container of claim 9 wherein the lobe is shaped like a cross-section of a polyhedron.

11. The container of claim 9 wherein the lobe has a front, a top, a first side, a second side, and an interior, wherein the front protrudes away from the top of the lid.

12. The container of claim 2 wherein the force generating element is a spring coil.
